(19) United States
(12) Patent Application Publication
(10) Pub. No.: US 2011/0250340 A1
(43) Pub. Date: Oct. 13, 2011

(54) SHELF STABLE NUTRITIONAL LIQUIDS COMPRISING BETA ALANINE

(75) Inventor: Paul W. Johns, Columbus, OH (US)

(73) Assignee: ABBOTT LABORATORIES, Abbott Park, IL (US)

(21) Appl. No.: 13/079,895

(22) Filed: Apr. 5, 2011

Related U.S. Application Data
(60) Provisional application No. 61/320,913, filed on Apr. 5, 2010.

(51) Int. Cl. A23L 2/52; A23L 1/305; A23L 2/66

(52) U.S. Cl. 426/590

(57) ABSTRACT

Disclosed are shelf-stable nutritional liquids comprising beta alanine, protein, and a carbohydrate system, wherein the shelf-stable nutritional liquid includes a molar ratio of the DE of the carbohydrate system to the lysine amino nitrogen of the protein of less than about 1.0 and or a molar ratio of the DE of the carbohydrate system to the beta alanine of less than about 3.0. The nutritional liquids are surprisingly stable over extended periods of time and exhibit minimal reduction in the concentration of beta alanine over shelf life.

### CROSS REFERENCE TO RELATED APPLICATION

This application claims the benefit of U.S. Provisional Application No. 61/320,913 filed Apr. 5, 2010, which disclosure is incorporated by reference in its entirety.

### FIELD OF THE DISCLOSURE

This disclosure relates to shelf stable nutritional liquids comprising beta alanine.

### BACKGROUND OF THE DISCLOSURE

Nutritional liquids have become increasingly popular as consumers concentrate on improving their overall health and well-being by consuming products, such as nutritional liquids, containing a balance of protein, carbohydrates, fats, vitamins, and or minerals. These nutritional liquids are often formulated with certain nutritional actives that help tailor the product to a specific therapeutic or nutritional benefit.

Beta alanine is one such nutritional active that has been formulated into a number of nutritional products, including certain nutritional liquids. Beta alanine is a non-essential naturally occurring beta amino acid that is the rate-limiting precursor of carnosine. Dietary supplementation with beta alanine has been shown to increase the concentration of carnosine in muscles, delay fatigue in athletes, and increase total muscular work done. Because beta alanine promotes the production of carnosine which can provide a number of benefits, beta alanine is a desirable ingredient for incorporation into nutritional liquids and other nutritional products.

Nutritional products containing beta alanine are often formulated in powder form, which are then reconstituted prior to use to form a drink or beverage comprising a bioavailable source of beta alanine. These drinks or beverages, however, are not typically shelf stable and should therefore be consumed immediately following reconstitution with water. Although nutritional powders tend to cost less than their shelf stable liquid counterparts, they are also difficult to prepare while on the go so that many consumers thus prefer the convenience of a shelf stable nutritional liquid.

It has been found, however, that formulating a shelf stable nutritional liquid with beta alanine often results in excessive reaction of the amino acid in the presence of water, especially in the presence of carbohydrates having a substantial reducing capacity, during high temperature processing and during prolonged storage under ambient conditions, the result of which is a product with unacceptably reduced beta alanine concentrations and a resulting abbreviated shelf life. This degradation of the beta alanine is even more problematic in nutritional liquids formulated at the higher pH ranges that typically favor accelerated degradation of the beta alanine. Unfortunately, such higher pH ranges (e.g., pH 5-8) are often needed to maintain stability of other pH sensitive ingredients, including many different protein systems that would otherwise destabilize when exposed to more acidic conditions.

There is therefore a need for nutritional liquids comprising beta alanine, especially shelf stable, protein-containing, liquids formulated at higher pH values, that comprise substantially stable beta alanine concentration during high temperature processing (that is required for most shelf stable products) and during storage under ambient conditions over extended periods of time.

### SUMMARY OF THE DISCLOSURE

One embodiment of the present disclosure includes shelf-stable nutritional liquids comprising beta alanine, protein, and a carbohydrate system, wherein the shelf-stable nutritional liquids include a molar ratio of the DE of the carbohydrate system to the lysine amino nitrogen of the protein of less than about 1.0.

Another embodiment of the present disclosure includes shelf-stable nutritional liquids comprising beta alanine, protein, and a carbohydrate system, wherein the shelf-stable nutritional liquids include a molar ratio of the DE of the carbohydrate system to the beta alanine of less than about 3.0.

Still another embodiment of the present disclosure includes shelf-stable nutritional liquids comprising beta alanine, protein, and a carbohydrate system, wherein the shelf-stable nutritional liquids include a molar ratio of the DE of the carbohydrate system to the lysine amino nitrogen of the protein of less than about 1.0 and a molar ratio of the DE of the carbohydrate system to the beta alanine of less than about 3.0.

Still another embodiment of the present disclosure includes shelf-stable nutritional liquids comprising beta alanine, protein, and a carbohydrate system, wherein the shelf-stable nutritional liquids have a pH of from about 5 to about 8 and include a molar ratio of the DE of the carbohydrate system to the lysine amino nitrogen of the protein of less than about 1.0 and or a molar ratio of the DE of the carbohydrate system to the beta alanine of less than about 3.0.

It has been found that that the stability of beta alanine in nutritional liquids during high temperature processing and during prolonged storage under ambient conditions is substantially improved by formulating with a selected molar ratio of the DE of the carbohydrate system to the lysine amino nitrogen of the protein in the nutritional liquid of less than about 1.0 and or a molar ratio of reducing carbohydrates to beta-alanine of less than about 3.0. It has been found that by controlling one or both of these selected ratios that beta alanine degradation is minimized over shelf life.

It has been found that such stability can even be realized in packaged nutritional liquids formulated at higher pH values and that contain protein, which higher values are known to be conducive to beta alanine degradation in an aqueous system. These findings have thus enabled the formulation of a packaged, shelf stable, nutritional liquid comprising stable concentrations of beta alanine over shelf life.

### DETAILED DESCRIPTION OF THE DISCLOSURE

The shelf stable nutritional liquids of the present disclosure comprise protein, beta alanine, a carbohydrate system, and at least one ingredient, feature, or element to improve product stability of the beta alanine over shelf life. The essential features of the nutritional liquids, as well as some of the many optional variations and additions, are described in detail hereafter.

The term “beta alanine” as used herein, unless otherwise specified, refers to a naturally occurring beta amino acid also known as 3-aminopropionic acid and having the molecular formula of C₃H₇NO₂, wherein the beta alanine is in free or dissociated form in the nutritional liquid.

The term “nutritional liquid” as used herein, unless otherwise specified, refers to liquids comprising carbohydrate and protein and that are suitable for oral administration to humans.

The terms “fat” and “oil” as used herein, unless otherwise specified, are used interchangeably to refer to lipid materials derived or processed from plants or animals. These terms also include synthetic lipid materials so long as such synthetic materials are suitable for oral administration to humans.

The term “shelf stable” as used herein, unless otherwise specified, refers to a nutritional liquid that remains commercially stable after being packaged and contained within a hermetically sealed container and then stored at 18-24° C. for at least 3 months, including from about 6 months to about 24 months, and also including from about 12 months to about 18 months. The shelf-stable formulations described herein, although stable when stored at such temperatures, may also be packaged and stored at lower or refrigerated temperatures.

All percentages, parts and ratios as used herein, are by weight of the total composition, unless otherwise specified. All such weights as they pertain to listed ingredients are based on the active level and, therefore, do not include solvents or by-products that may be included in commercially available materials, unless otherwise specified.

All references to singular characteristics or limitations of the present disclosure shall include the corresponding plural characteristic or limitation, and vice versa, unless otherwise specified or clearly implied to the contrary by the context in which the reference is made.

All combinations of method or process steps as used herein can be performed in any order, unless otherwise specified or clearly implied to the contrary by the context in which the referenced combination is made.

The various embodiments of the nutritional liquids of the present disclosure may also be substantially free of any optional or selected essential ingredient or feature described herein, provided that the remaining nutritional liquid still contains all of the required ingredients or features as described herein. In this context, and unless otherwise specified, the term “substantially free” means that the selected nutritional liquid contains less than a functional amount of the optional ingredient, typically less than about 0.5%, including less than about 0.1% and also including zero percent, by weight of such optional or selected essential ingredient.

The nutritional liquids and corresponding methods of the present disclosure can comprise, consist of, or consist essentially of the essential elements of the disclosure as described herein, as well as any additional or optional element described herein or otherwise useful in nutritional liquid formula applications.

### Product Form

The nutritional liquids of the present disclosure are shelf stable, aqueous liquids, which may include aqueous solutions, emulsions, and suspensions, each of which comprises protein, beta alanine, and carbohydrate. These nutritional liquids are flowable or drinkable at temperatures ranging from about 1° C. to about 25° C.

The nutritional liquids include emulsions such as oil-in-water, water-in-oil, or complex aqueous emulsions, although such emulsions are most typically in the form of oil-in-water emulsions having a continuous aqueous phase and a discontinuous oil phase.

The nutritional liquids typically contain up to about 98% by weight of water, including from about 50% to about 95%, also including from about 60% to about 90%, and also including from about 70% to about 85%, of water by weight of the nutritional liquids.

The nutritional liquids may be formulated with sufficient kinds and amounts of nutrients so as to provide a sole, primary, or supplemental source of nutrition, or to provide a specialized nutritional liquid for use in individuals afflicted with specific diseases or conditions or who have a specific therapeutic target such as improved athletic performance, reduce muscle fatigue, improved muscle strength, and so forth.

These nutritional liquids may thus have a variety of product densities, but most typically have a density greater than about 1.055 g/ml, including from 1.06 g/ml to 1.12 g/ml, and also including from about 1.085 g/ml to about 1.10 g/ml.

The nutritional liquids may have a pH selected for compatibility with the ingredients in the formulation and selected for the desired taste profile, although such pH values most typically range from about 5.0 to about 8, including from about 5.0 to about 7.5, also including from about 6.0 to about 7.0, and also including from about 6.2 to about 6.8.

Although the serving size for the nutritional liquids can vary depending upon a number of variables, a typical serving size ranges from about 100 to about 600 ml, including from about 150 to about 500 ml, including from about 190 ml to about 240 ml.

### Beta Alanine

The nutritional liquids comprise beta alanine, which means that the nutritional liquids are either formulated with the addition of beta alanine, or are otherwise prepared so as to contain beta alanine in the finished product. Any source of beta alanine is suitable for use herein provided that the finished product contains free beta alanine at the desired level.

The concentration of beta alanine may range from about 0.1% to about 3.0%, including from about 0.1% to about 2.0%, also including from about 0.1% to about 1.0%, and also including about 0.1% to about 0.33%, by weight of the nutritional liquid. These concentrations refer to free beta alanine in the nutritional liquids and do not include or reflect any beta alanine that may be inherent in a protein component in the formulation.

### Protein

The nutritional liquids comprise a protein or protein source, which may include intact or partially hydrolyzed protein. Any protein source is suitable for use herein provided that it is also suitable for use in oral nutritional products and is otherwise compatible with any other selected ingredients or features in the formulation.

Protein concentrations in the nutritional liquids may vary depending upon the nutritional needs of the targeted user as well as the physical and stability requirements of the selected formulation. Such concentrations, however, most typically range from about 0.5% to about 30%, including from about 1% to about 15%, and also including from about 2% to about 10%, by weight of the nutritional liquid.

Non limiting examples of suitable protein sources include those derived from milk (e.g., casein, whey), animal (e.g., meat, fish), cereal (e.g., rice, corn), vegetable (e.g., soy), or combinations thereof, specific examples of which include milk protein isolates, casein protein isolates, collagen or hydrolyzed collagen, sodium or calcium caseinates, milk protein concentrate, whole cows milk, partially or completely defatted milk, soy protein isolates, and so forth.

The protein or partially hydrolyzed protein provides the lysine amino nitrogen to which the molar ratio of the DE of the carbohydrate system to lysine amino nitrogen referenced herein refers. It is believed that the lysine component of the protein or partially hydrolyzed protein reacts more readily with the reducing carbohydrates, and thus reduces the reaction with and degradation of the beta alanine in the nutritional liquid.

It is therefore desirable to formulate the nutritional liquids with sufficient protein, and with sufficient lysine inherently in the protein, to provide the formulation with the molar ratio of the DE of the carbohydrate system to the lysine amino nitrogen of less than 1.0. Lysine amino nitrogen content of protein or protein hydrolysates may be measured, calculated, or otherwise determined by any of several commonly known methods in the art.

### Carbohydrate System

The nutritional liquids comprise a carbohydrate system having a Dextrose Equivalent Value (DE value) characterized by its molar ratio to either to the beta alanine or to the lysine amino nitrogen content of the nutritional liquid. For purposes of the present disclosure, the carbohydrate system may include one or more carbohydrates from any source that is suitable for use in an oral nutritional product and is otherwise compatible with the other selected ingredients or features in the formulation.

The carbohydrate system may include one or more carbohydrates which collectively provide the protein-containing nutritional liquid herein with a molar ratio of the DE of the carbohydrate system to the lysine amino nitrogen content of less than 2.0, including less than 1.0, and also including from about 0.1 to about 0.9, and or a molar ratio of the DE of the carbohydrate system to the beta alanine content of the system of less than 3, including less than 1.0, also including less than 0.5, and also including from 0.01 to about 0.3.

The carbohydrate system may include any DE value so long as the molar ratios of those values relative to the lysine amino nitrogen content and or the beta alanine content of the nutritional liquid are within the ranges as described herein. Such DE values, however, most typically range from about 1 to about 10, including from about 1 to about 5. Such DE values may also range from zero to about 1, including zero to about 0.5.

The concentration of carbohydrates in the nutritional liquids may vary so as to accommodate the above-noted molar ratios. Such concentrations, however, most typically range from about 5% to about 40%, including from about 7% to about 30%, and also including from about 10% to about 25%, by weight of the nutritional liquid.

The term “reducing capacity” as used herein refers to the degree to which carbohydrates or sugars readily oxidize or react with Tollen's, Benedict's or Fehling's reagents. The reducing capacity of individual carbohydrates or combinations of carbohydrates can be characterized by the “dextrose equivalent” or “DE” value of such carbohydrates.

For example, a maltodextrin making up the carbohydrate system of a nutritional liquid and having a DE of 10 comprises 10% reducing sugars, on a molar basis, for purposes of calculating the molar ratios of the DE of the carbohydrate system to either the lysine amino nitrogen content or the beta alanine content of the formulation.

The nutritional liquids include those embodiments in which some or all of the carbohydrate system comprises lactose, which in many instances is partially or entirely provided as an ingredient inherently associated with the added protein when such protein is derived from bovine or other milk source.

Non-limiting examples of reducing carbohydrates suitable for use herein include glucose, fructose, lactose, and galactose. It should be noted, however, that many carbohydrates suitable for use herein provide the nutritional liquid with both a reducing and a non reducing carbohydrate component. For example, if the nutritional liquid is formulated with 100 moles of a maltodextrin having a DE of 10, then the maltodextrin would provide for calculation purposes herein 10 moles of reducing carbohydrate and 90 moles of non reducing carbohydrate.

Non-limiting examples of non-reducing carbohydrates suitable for use herein include sucrose, trehalose, and other similar materials having neither the keto nor aldehyde moieties with which to react with the beta-alanine in the formulation. As noted earlier, however, the non-reducing carbohydrate can be provided by the non-reducing fraction of a carbohydrate based on the DE calculation noted above.

Non-limiting examples of carbohydrates suitable for use in the nutritional liquids include hydrolyzed or intact, naturally and/or chemically modified, starches sourced from corn, tapioca, rice, potato or other plant source, in waxy or non-waxy forms. Other non-limiting examples of suitable carbohydrate sources include hydrolyzed or modified starch or cornstarch or maltodextrins.

### Fat

The nutritional liquids may further comprise an optional fat or fat source, especially when the nutritional liquid is formulated as an emulsion, most typically as an oil-in-water emulsion. Any fat source is suitable for use herein provided that it is also suitable for use in an oral nutritional product and is otherwise compatible with any other selected ingredients or features in the formulation.

The concentration of optional fat in the nutritional emulsions or liquids may range from about 1% to about 30%, including from about 2% to about 15%, and also including from about 4% to about 10%, by weight of the nutritional emulsion or liquid.

Non-limiting examples of fats or sources thereof suitable for use herein include coconut oil, fractionated coconut oil, soy oil, corn oil, olive oil, safflower oil, high oleic safflower oil, MCT oil (medium chain triglycerides), MCT canola structured lipids, sunflower oil, high oleic sunflower oil, palm and palm kernel oils, palm olein, canola oil, marine oils, cottonseed oils, and combinations thereof.

The level or amount of carbohydrate, protein and optional fat in the nutritional liquids may also be characterized in addition to or in the alternative as a percentage of total calories in the nutritional compositions as set forth in the following table.

| Nutrient | | | |
|---|---|---|---|
| (% Total calories) | Embodiment A | Embodiment B | Embodiment C |
| Carbohydrate | 1-98 | 10-75 | 30-50 |
| Fat | 1-98 | 20-85 | 35-55 |
| Protein | 1-98 | 5-70 | 15-35 |

The nutritional liquids of the present disclosure, including the emulsion embodiments, may also be formulated to be substantially free (as that term is defined herein) of reducing carbohydrates.

### Stability

The packaged, shelf stable, nutritional liquids of the present disclosure remain stable for at least 3 months, including at least 6 months, and also including from about 3 months to about 18 months, following the time of manufacture and packaging.

In this context, the stability of the nutritional liquid refers to the ability of the formulation to maintain beta-alanine concentrations over shelf life with minimal or no reductions (e.g., reductions in beta alanine from degradation) despite the presence of a carbohydrate system potentially having some reducing capacity. It has been found that carbohydrates systems having some reducing capacity can be formulated with beta-alanine with minimal degradation provided that the relationship between the DE of the carbohydrate system and the beta alanine and or lysine amino nitrogen content as described herein are satisfied.

The stability of the beta alanine during processing and over shelf life in the context of the present disclosure means that less than about 10%, including less than about 5%, including less than 3%, by weight of the beta alanine is degraded during high temperature processing and or during the selected shelf life.

### Optional Ingredients

The nutritional liquids may further comprise other optional ingredients that may modify the physical, chemical, hedonic or processing characteristics of the products or serve as pharmaceutical or additional nutritional components when used in the targeted population. Many such optional ingredients are known or otherwise suitable for use in other nutritional products and may also be used in the nutritional liquids described herein, provided that such optional ingredients are safe and effective for oral administration and are compatible with the essential and other ingredients in the selected product form.

Non-limiting examples of such optional ingredients include preservatives, antioxidants, emulsifying agents, buffers, pharmaceutical actives, additional nutrients as described herein, colorants, flavors, thickening agents, and stabilizers, and so forth.

The nutritional liquids may further comprise vitamins or related nutrients, non-limiting examples of which include vitamin A, vitamin D, vitamin E, vitamin K, thiamine, riboflavin, pyridoxine, vitamin B12, carotenoids, niacin, folic acid, pantothenic acid, biotin, vitamin C, choline, inositol, salts, and derivatives thereof, and combinations thereof.

The nutritional liquids may further comprise minerals, non-limiting examples of which include phosphorus, calcium, magnesium, iron, zinc, manganese, copper, sodium, potassium, molybdenum, chromium, selenium, chloride, and combinations thereof.

### Method of Use

The nutritional liquids may be useful in providing supplemental, primary, or sole sources of nutrition, and or in providing individuals with one or more other benefits as described herein. In accordance with such methods, the liquids may be administered orally as needed to provide the desired level of nutrition and or to provide the desired benefit from the beta alanine.

The nutritional liquids are most typically administered as a single serving prior to or immediately following exercise, with serving sizes most typically ranging from about 100 to about 600 ml, including from about 150 to about 500 ml, including from about 190 ml to about 240 ml, wherein each serving contains from about 0.4 to about 3.0 g, including from about 0.75 to about 2.0 g, including about 1.7 g, of beta alanine.

The nutritional liquids may be administered as noted above or as otherwise appropriate under the circumstances to provide an individual with one or more of 1) increased muscle strength and power output, 2) increased muscle mass, 3) increased anaerobic endurance, 4) delayed muscle fatigue during exercise, and 5) enhanced recovery after exercise.

### Methods of Manufacture

The nutritional liquids may be manufactured by any known or otherwise suitable method for making nutritional liquids.

In one suitable manufacturing process, at least three separate slurries are prepared, including a protein-in-fat (PIF) slurry, a carbohydrate-mineral (CHO-MIN) slurry, and a protein-in-water (PIW) slurry. The PIF slurry is formed by heating and mixing the selected oils (e.g., canola oil, corn oil, etc.) and then adding an emulsifier (e.g., lecithin), fat soluble vitamins, and a portion of the total protein (e.g., milk protein concentrate, etc.) with continued heat and agitation. The CHO-MIN slurry is formed by adding with heated agitation to water: minerals (e.g., potassium citrate, dipotassium phosphate, sodium citrate, etc.), trace and ultra trace minerals (TM/UTM premix), thickening or suspending agents (e.g. Avicel, gellan, carrageenan), and beta alanine or beta alanine source. The resulting CHO-MIN slurry is held for 10 minutes with continued heat and agitation before adding additional minerals (e.g., potassium chloride, magnesium carbonate, potassium iodide, etc.) and/or carbohydrates (e.g., frucotooligosaccharide, sucrose, corn syrup, etc.). The PIW slurry is then formed by mixing with heat and agitation the remaining protein (e.g., sodium caseineate, soy protein concentrate, etc.) into water.

The resulting slurries are then blended together with heated agitation and the pH adjusted to the desired range, typically from 6.6-7.0, after which the composition is subjected to high-temperature short-time (HTST) processing during which the composition is heat treated, emulsified and homogenized, and then allowed to cool. Water soluble vitamins and ascorbic acid are added, the pH is again adjusted to the desired range if necessary, flavors are added, and water is added to achieve the desired total solid level. The composition is then aseptically packaged to form an aseptically packaged nutritional liquid, or the composition is added to retort stable containers and then subjected to retort sterilization to form retort sterilized nutritional liquids.

The manufacturing processes for the nutritional liquids may be carried out in ways other than those set forth herein without departing from the spirit and scope of the present invention. The present embodiments are, therefore, to be considered in all respects illustrative and not restrictive and that all changes and equivalents also come within the description of the present disclosure.

### EXAMPLES

The following examples illustrate specific embodiments and or features of the nutritional liquids of the present disclosure. The examples are given solely for the purpose of illustration and are not to be construed as limitations of the present disclosure, as many variations thereof are possible without departing from the spirit and scope of the disclosure. All exemplified amounts are weight percentages based upon the total weight of the composition, unless otherwise specified.

The exemplified compositions of Example 1 (Samples A and B) and Examples 2-9 are packaged, shelf stable, nutritional liquids prepared in accordance with the manufacturing methods described herein, such that each exemplified composition, unless otherwise specified, includes an aseptically processed embodiment and a retort packaged embodiment. All embodiments are packaged in 240 ml containers suitable for aseptic or retort sterilization. The beta alanine concentrations in each formulation does not decrease by more than 5% after storage under environmental temperatures of from 1-25° C. for 6 months following manufacture.

### Example 1

Example 1 illustrates the stability of beta-alanine in the nutritional liquids as described herein. Sample nutritional liquids are prepared and their beta alanine content measured following high temperature processing and prolonged storage under ambient conditions.

Samples A and B are emulsion embodiments of the present disclosure with the required molar ratios of the DE of the carbohydrate system to the lysine amino nitrogen content (less than 1.0) and the required molar ratios of the DE of the carbohydrate system to the beta alanine content (less than 3.0). Samples A and B have similar formulations but differ in their flavor systems.

Samples C-G are nutritional liquids (substantially clear, non-emulsified liquids) whose molar ratios of the DE of the carbohydrate system to the lysine amino nitrogen content and whose molar ratios of the DE of the carbohydrate system to the beta alanine content fall outside the selected ranges of the present disclosure. Samples C-G have similar formulations but differ in their flavor systems.

All samples are manufactured by well established techniques for preparing and packaging nutritional liquids into similar 240 ml, retort stable, plastic containers. Listed amounts are in kg per 1000 kg of sample product.

Nutritional Liquids: Oil-in-water Emulsions ^{1, 2}

| Ingredient | Samples A and B |
|---|---|
| Water | 869.37 |
| Milk Protein Concentrate | 47.50 |
| Calcium Caseinate | 24.50 |
| Maltodextrin DE 10 | 20.73 |
| MCT Canola Structured Lipid | 7.00 |
| Fructooligosaccharides | 6.07 |
| High Oleic Sunflower Oil | 5.50 |
| Whey Protein Isolate | 4.50 |
| Beta Alanine | 3.30 |
| Magnesium Phosphate, Dibasic | 2.50 |
| Potassium Citrate, Monohydrate | 2.50 |
| Stabilizer | 1.50 |
| Sodium Ascorbate | 1.30 |
| Sodium Chloride | 0.60 |
| Vitamin/Mineral Premix | 0.56 |
| Flavoring | 1.69 |
| Liquid Sucralose 25% | 0.31 |
| Carrageenan | 0.30 |
| Gellan Gum | 0.15 |
| Acesulfame Potassium | 0.12 |

¹ pH 6.8
² Different flavor systems for Samples A and B

Nutritional Liquids: Non Emulsions ^{1, 2}

| Ingredient Name | Samples C, D, E, F, G |
|---|---|
| Water | 918.2390 |
| Isomaltulose | 30.8188 |
| Whey Protein Isolate | 19.0000 |
| Granular Sucrose | 18.0000 |
| Citric Acid | 3.0865 |
| Phosphoric Acid 75% | 3.0865 |
| Beta Alanine | 2.2601 |
| Calcium salt | 2.0546 |
| Flavor system | 1.5000 |
| Trisodium Citrate Dihydrate | 0.8000 |
| Sodium Chloride | 0.5400 |
| Liquid Sucralose 25% | 0.2500 |
| Dipotassium Phosphate | 0.1920 |
| Acesulfame Potassium | 0.1500 |
| Colorant | 0.0200 |

¹ pH 3.55-3.70
² Different flavor systems for each of Samples C-G

Each Sample is analyzed via gradient reversed phase HPLC with fluorescence detection to determine the long term stability (i.e., concentration) of beta alanine in the nutritional liquids. The fluorescent tag in the analysis is N-9-FluorenylMethOxyCarbonyl (FMOC) and the reference material is a standard beta alanine solution available from Sigma Aldrich (St. Louis, Mo.). The results of the analysis are summarized below.

| | | | | | Molar ratio | |
|---|---|---|---|---|---|---|
| | | | | Molar ratio | reducing | |
| | | | | of reducing | carb to lysine | |
| | Storage | | | carb to beta | amino | β-alanine |
| Product | time | | pH | alanine | nitrogen | % of target |
| Sample A | ~6 | mo | 6.8 | 0.39 | 0.38 | 107% |
| Sample B | ~6 | mo | 6.8 | 0.39 | 0.38 | 110% |
| Sample C | ≦~1 | mo | 3.6 | 3.55 | 8.46 | 93.4% |
| Sample D | ≦~1 | mo | 3.5 | 3.55 | 8.46 | 92.2% |
| Sample E | ≦~1 | mo | 3.5 | 3.55 | 8.46 | 94.5% |
| Sample F | ≦~1 | mo | 3.5 | 3.55 | 8.46 | 100.6% |
| Sample G | ≦~1 | mo | 3.5 | 3.55 | 8.46 | 102.0% |

Samples A and B: Maillard active component ratio in Sample Emulsions

| | | DE or Reducing sugar | Amino nitrogen |
|---|---|---|---|
| Maillard Active | Concentration | contribution ^{b} | contribution ^{c}, |
| Component | g/kg | mmoles/kg | mmoles/kg |
| Lactose ^{d} | 1.00 | 2.92 | 0 |
| Maltrin 100 ^{e} | 20.73 | 11.52 | 0 |
| β-alanine | 3.30 | 0 | 37.04 |
| MPC 80 ^{f} | 47.5 | 0 | 23.20 |
| CaCaseinate ^{g} | 24.5 | 0 | 12.15 |
| WPI ^{h} | 4.50 | 0 | 2.52 |

| | | |
|---|---|---|
| Totals | 14.44 | 74.91 |

| | |
|---|---|
| Ratio of reducing sugar to amino N | 0.19 |
| “β-alanine available reducing sugar” (“BAARS”) ⁱ | 0 |

^{b} based on lactose Molecular Weight (MW) = 342, and glucose MW = 180
^{c} based on β-alanine MW = 89.09, and lysine MW = 146.19
^{d} measured lactose concentration from added protein
^{e} DE = 10% (w/w)
^{f} lysine concentration = 7.14%, w/w (3)
^{g} lysine concentration = 7.25%, w/w (3)
^{h} lysine concentration = 8.19%, w/w (3)
ⁱ “BAARS“ = reducing sugars (14.44)-total lysine amino N (37.87) = 0

Sample C-G: Maillard active components

| | | Reducing sugar | Amino N |
|---|---|---|---|
| Maillard Active | Concentration | contributions^{b}, | contribution^{c}, |
| Component | g/kg | mmoles/kg | mmoles/kg |
| Isomaltulose | 30.82 | 90.04 | 0 |
| β-alanine | 2.26 | 0 | 25.37 |
| WPI^{d} | 19.00 | 0 | 10.64 |

| | | |
|---|---|---|
| Totals | 90.04 | 36.01 |

| | |
|---|---|
| Ratio of reducing sugar to amino N | 2.50 |
| “β-alanine available reducing sugar” (“BAARS”)^{e} | 79.40 |

^{b}based on isomaltulose MW = 342.3
^{c}based on β-alanine MW = 89.09, and lysine MW = 146.19
^{d}lysine concentration = 8.19%, w/w (3)
^{e}BAARS” = reducing sugars (90.04) -total lysine amino N (10.64) = 79.40

### Examples 2-5

Examples 2-5 illustrate nutritional liquids (emulsion embodiments) of the present disclosure, the ingredients of which are listed in the table below. All ingredient amounts are listed as pounds per 1000 pounds batch of product, unless otherwise specified.

| Ingredient | Example 2 | Example 3 | Example 4 | Example 5 |
|---|---|---|---|---|
| Filtered Reverse Osmosis | 869.37 | 869.37 | 869.37 | 869.37 |
| Water | | | | |
| Milk Protein Concentrate | 47.50 | 45.50 | 43.50 | 41.50 |
| Calcium Caseinate | 24.50 | 23.50 | 22.50 | 21.50 |
| Maltodextrin DE 10 | 20.73 | 22.73 | 24.73 | 26.73 |
| MCT Canola Structured | 7.00 | 7.00 | 7.00 | 7.00 |
| Lipid | | | | |
| Fructooligosaccharides | 6.07 | 6.07 | 6.07 | 6.07 |
| High Oleic Sunflower Oil | 5.50 | 5.50 | 5.50 | 5.50 |
| Whey Protein Isolate | 4.50 | 4.50 | 4.50 | 4.50 |
| Beta Alanine | 3.30 | 4.30 | 5.30 | 6.30 |
| Magnesium Phosphate, | 2.50 | 2.50 | 2.50 | 2.50 |
| Dibasic | | | | |
| Potassium Citrate, | 2.50 | 2.50 | 2.50 | 2.50 |
| Monohydrate | | | | |
| Stabilizer | 1.50 | 1.50 | 1.50 | 1.50 |
| Sodium Ascorbate | 1.30 | 1.30 | 1.30 | 1.30 |
| Sodium Chloride | 0.60 | 0.60 | 0.60 | 0.60 |
| Vitamin/Mineral Premix | 0.56 | 0.56 | 0.56 | 0.56 |
| Flavoring | 1.69 | 1.69 | 1.69 | 1.69 |
| Sucralose Liquid | 0.31 | 0.31 | 0.31 | 0.31 |
| Concentrate | | | | |
| Carrageenan | 0.30 | 0.30 | 0.30 | 0.30 |
| Gellan Gum | 0.15 | 0.15 | 0.15 | 0.15 |
| Acesulfame Potassium | 0.12 | 0.12 | 0.12 | 0.12 |

### Examples 6-9

Examples 6-9 illustrate nutritional liquids (emulsion embodiments) of the present disclosure, the ingredients of which are listed in the table below. All ingredient amounts are listed as pounds per 1000 pounds batch of product, unless otherwise specified.

| Ingredient | Example 6 | Example 7 | Example 8 | Example 9 |
|---|---|---|---|---|
| Filtered Reverse Osmosis | 869.37 | 89.37 | 869.37 | 869.37 |
| Water | | | | |
| Milk Protein Concentrate | 46.50 | 43.50 | 40.50 | 41.50 |
| Calcium Caseinate | 23.50 | 21.50 | 19.50 | 17.50 |
| Maltodextrin DE 10 | 20.73 | 22.73 | 24.73 | 26.73 |
| MCT Canola Structured | 8.00 | 9.00 | 10.00 | 7.00 |
| Lipid | | | | |
| Fructooligosaccharides | 7.07 | 8.07 | 9.07 | 10.07 |
| High Oleic Sunflower Oil | 5.50 | 5.50 | 5.50 | 5.50 |
| Whey Protein Isolate | 4.50 | 4.50 | 4.50 | 4.50 |
| Beta Alanine | 3.30 | 4.30 | 5.30 | 6.30 |
| Magnesium Phosphate, | 2.50 | 2.50 | 2.50 | 2.50 |
| Dibasic | | | | |
| Potassium Citrate, | 2.50 | 2.50 | 2.50 | 2.50 |
| Monohydrate | | | | |
| Stabilizer | 1.50 | 1.50 | 1.50 | 1.50 |
| Sodium Ascorbate | 1.30 | 1.30 | 1.30 | 1.30 |
| Sodium Chloride | 0.60 | 0.60 | 0.60 | 0.60 |
| Vitamin/Mineral Premix | 0.56 | 0.56 | 0.56 | 0.56 |
| Flavoring | 1.69 | 1.69 | 1.69 | 1.69 |
| Sucralose Liquid | 0.31 | 0.31 | 0.31 | 0.31 |
| Concentrate | | | | |
| Carrageenan | 0.30 | 0.30 | 0.30 | 0.30 |
| Gellan Gum | 0.15 | 0.15 | 0.15 | 0.15 |
| Acesulfame Potassium | 0.12 | 0.12 | 0.12 | 0.12 |

What is claimed is:

1. A shelf-stable nutritional liquid comprising beta alanine, protein, and a carbohydrate system, wherein the shelf-stable nutritional liquid includes a molar ratio of the DE of the carbohydrate system to the lysine amino nitrogen of the protein less than about 1.0.

2. The nutritional liquid of claim 1 wherein the molar ratio ranges from about 0.001 to about 1.0.

3. The nutritional liquid of claim 1 wherein the carbohydrate system has a DE of from about 1 to about 10.

4. The nutritional liquid of claim 1 wherein the carbohydrate system has a DE of from zero to about 1.

5. The nutritional liquid of claim 1 wherein the beta alanine represents from about 0.1% to about 3.0% by weight of the nutritional liquid.

6. The nutritional liquid of claim 1 further comprising fat, wherein the nutritional liquid is an oil-in-water liquid comprising from about 0.5% to about 30% protein, from about 1% to about 30% fat, and from about 5% to about 40% carbohydrate, all by weight of the nutritional liquid.

7. A shelf-stable nutritional liquid comprising beta alanine, protein, and a carbohydrate system, wherein the shelf-stable nutritional liquid includes a molar ratio of the DE of the carbohydrate system to the beta alanine of less than about 3.0.

8. The nutritional liquid of claim 7 wherein the molar ratio ranges from about 0.001 to about 1.0.

9. The nutritional liquid of claim 7 wherein the carbohydrate system has a DE of from about 1 to about 10.

10. The nutritional liquid of claim 7 wherein the carbohydrate system has a DE of from zero to about 1.

11. The nutritional liquid of claim 7 wherein the beta alanine represents from about 0.1% to about 3.0% by weight of the nutritional liquid.

12. The nutritional liquid of claim 7 further comprising fat, wherein the nutritional liquid is an oil-in-water emulsion comprising from about 0.5% to about 30% protein, from about 1% to about 30% fat, and from about 5% to about 40% carbohydrate, all by weight of the nutritional liquid.

13. The nutritional liquid of claim 7 wherein the liquid is a packaged, shelf stable, nutritional liquid having a shelf life of at least about 3 months.

14. The nutritional liquid of claim 7 wherein the liquid is a packaged, shelf stable, nutritional liquid wherein at least 95% of the beta alanine on a molar basis remains 6 months after formulation and packaging.

15. The nutritional liquid of claim 7 wherein the carbohydrate system comprises lactose.

16. A shelf-stable nutritional liquid comprising beta alanine, protein, and a carbohydrate system, wherein the shelf-stable nutritional liquid includes a molar ratio of the DE of the carbohydrate system to the lysine amino nitrogen of the protein of less than about 1.0 and a molar ratio of the DE of the carbohydrate system to the beta alanine of less than about 3.0.

17. The nutritional liquid of claim 16 wherein the molar ratio of the DE of the carbohydrate system to the lysine amino nitrogen of the protein from about 0.001 to about 1.0 and the molar ratio of the carbohydrate system to beta alanine ranges from about 0.001 to about 1.0.

18. The nutritional liquid of claim 16 wherein the carbohydrate system has a DE of from about 1 to about 10.

19. The nutritional liquid of claim 16 wherein the carbohydrate system has a DE of from zero to about 1.

20. The nutritional liquid of claim 16 wherein the beta alanine represents from about 0.1% to about 3.0% by weight of the nutritional liquid.
